(19) United States
(12) Patent Application Publication
(10) Pub. No.: US 2007/0078668 A1
(43) Pub. Date: Apr. 5, 2007

(54) Authentication ID interview method and apparatus

(76) Inventors: Dimpy Pathria, Burr Ridge, IL (US); John Wesley Davison, San Diego, CA (US); Robert James Warner, Poway, CA (US); James Harry Bishop, San Diego, CA (US)

Correspondence Address: GLENN PATENT GROUP, 3475 EDISON WAY, SUITE L, MENLO PARK, CA, 94025, US

(21) Appl. No.: 11/240,856

(22) Filed: Sep. 30, 2005

(51) Int. Cl. G06Q 99/00

(52) U.S. Cl. 705/1

(57) ABSTRACT

A method and apparatus are disclosed for determining whether a responder is who he or she claims to be, by evaluating responses to a series of questions drawn from various data providers, e.g. real estate data about the responder's house; family members from other publicly available sources; etc. The invention also comprises a novel empirically-derived scoring component that is used to evaluate the likelihood that correct/incorrect responses to the multiple choice questions is fraud, i.e. an impersonator.

### BACKGROUND OF THE INVENTION

1. Technical Field

The invention relates to fraud detection. More particularly, the invention relates to a method and apparatus for authenticating an individual's identity.

2. Description of the Prior Art

In many cases, an individual's identity must be authenticated in circumstances where the individual is otherwise easily impersonated, e.g. during on-line or telephone transactions. It would be advantageous to provide a method and apparatus for determining whether an individual is who he says he is in such situations.

### SUMMARY OF THE INVENTION

The invention provides a method and apparatus for determining whether a responder is who he says he is by evaluating responses to a series of questions drawn from various data providers, e.g. real estate data about the responder's house; family members from other publicly available sources; etc. The invention also comprises a novel scoring component that is used to evaluate the likelihood that correct/incorrect responses to the multiple choice questions is indicative of fraud, i.e. an impersonator.

### BRIEF DESCRIPTION OF THE DRAWINGS

FIG. 1 is a screen shot that shows a multiple correct choice question according to the invention;

FIG. 2 is a screen shot that shows a single correct choice question according to the invention;

FIG. 3 is a block schematic diagram showing entity relations in an authentication ID interview method and apparatus according to the invention;

FIG. 4 is a block schematic diagram showing authentication service relations for an interview question request in an authentication ID interview method and apparatus according to the invention;

FIG. 5 is a block schematic diagram showing authentication service sequence for an interview question request during initial question creation using a new data source in an authentication ID interview method and apparatus according to the invention;

FIG. 6 is a block schematic diagram showing authentication service sequence for an interview question request during a subsequent question creation using an existing data source in an authentication ID interview method and apparatus according to the invention; and

FIG. 7 is a block schematic diagram showing authentication service sequence for an interview response when submitting a final answer to an interview in an authentication ID interview method and apparatus according to the invention.

### DETAILED DESCRIPTION OF THE INVENTION

The invention provides a method and apparatus for determining whether a responder is who he says he is by evaluating responses to a series of questions drawn from various data providers, e.g. real estate data about the responder's house; family members from other publicly available sources; etc. The invention comprises a novel scoring component that is used to evaluate the likelihood that correct/incorrect responses to the multiple choice questions is indicative of fraud, i.e. an impersonator.

Thus, the invention provides an authentication service that is used to determine if an identity is true or not. The authentication service generates a series of questions from a range of categories. The person with the identity in question takes an interview and the resulting answers are scored by an authentication service model.

How the interview questions are displayed is configurable by the institution (also referred to as a “client” or a “customer” herein) asking the questions. Institutions can pick and chose which questions they want from a pool of possible questions. They also set the number of questions that comprise an interview from the pool of selected questions. The presentation of the choices is also configurable. An institution can specify whether there can be one or more correct choices, whether there is a “none” choice, or whether the answer is supplied by the interviewee (fill in the blank).

The results of an interview are stored in a clearinghouse. If the interviewee attempts another interview, either at a different or the same institution, the questions contained in the new interview are as unique as possible. The authentication service first exhausts all questions that have not been presented to the interviewee before using previously asked questions.

The interviewee has a predetermined amount of time to complete the interview. If the interview is not completed in the set amount of time it is assumed abandoned.

In one embodiment, if an interviewee postpones an interview it always starts with the last unanswered question. In other embodiments, it may not be possible to track how far in the interview the interviewee got before abandoning the interview. In such cases, it is assumed that the interviewee has viewed all questions. Never should the interviewee have an opportunity to correct a previous answer.

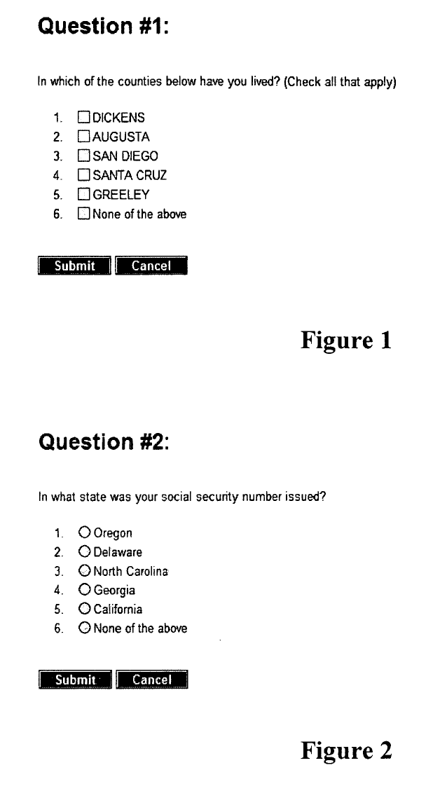

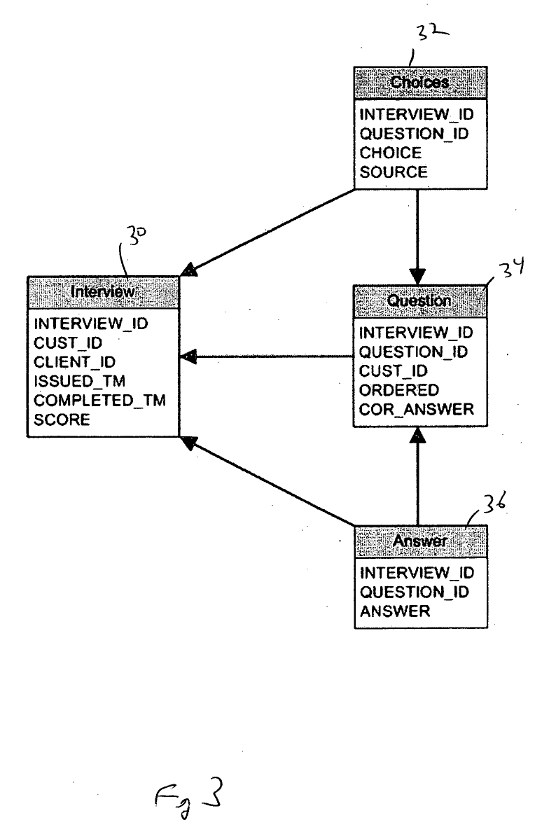

FIGS. 1 and 2 provide example screen shots, in which FIG. 1 shows a multiple correct choice question and FIG. 2 shows a single correct choice question.

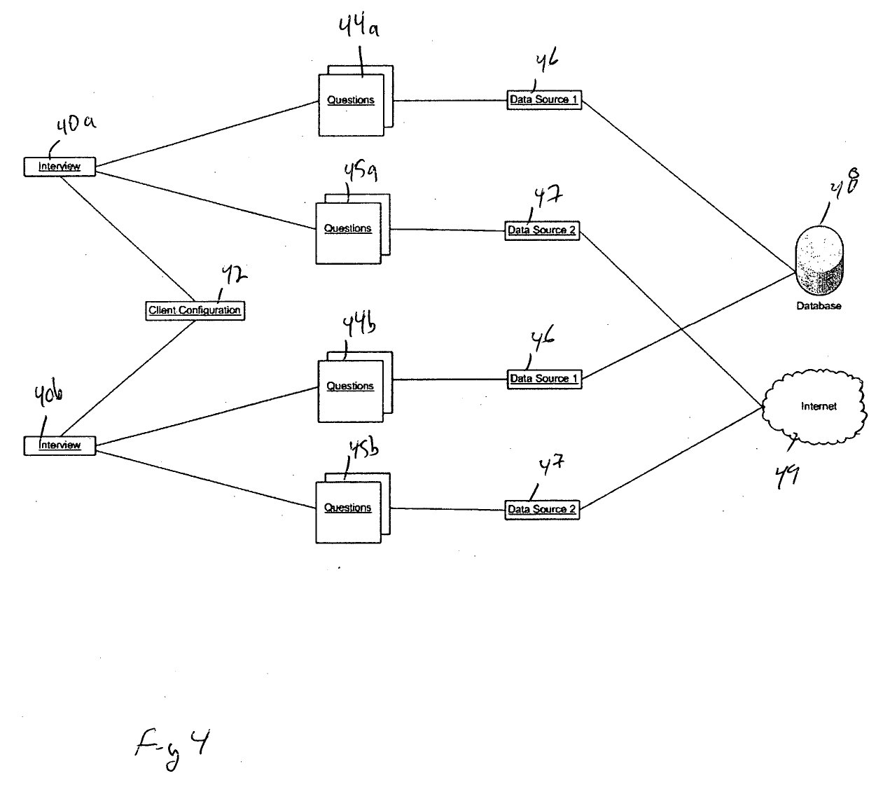

FIG. 3 is a block schematic diagram showing entity relations in an authentication ID interview method and apparatus according to the invention. In one embodiment, the invention comprises an interview 30 which includes an interview ID, a cust(omer)_id, a client ID, an issued_tm (tm=time), a completed_tm, and a score. The interview is based upon choices 32 made for the interview by the customer, including the interview ID, question ID, choice, and source. The choices affect the question 34 which, in turn, includes an interview ID, question ID, customer ID, ordered (order of question presentation), and cor(rect)_answer. The answer component 36 includes an interview ID, question ID, and answer.

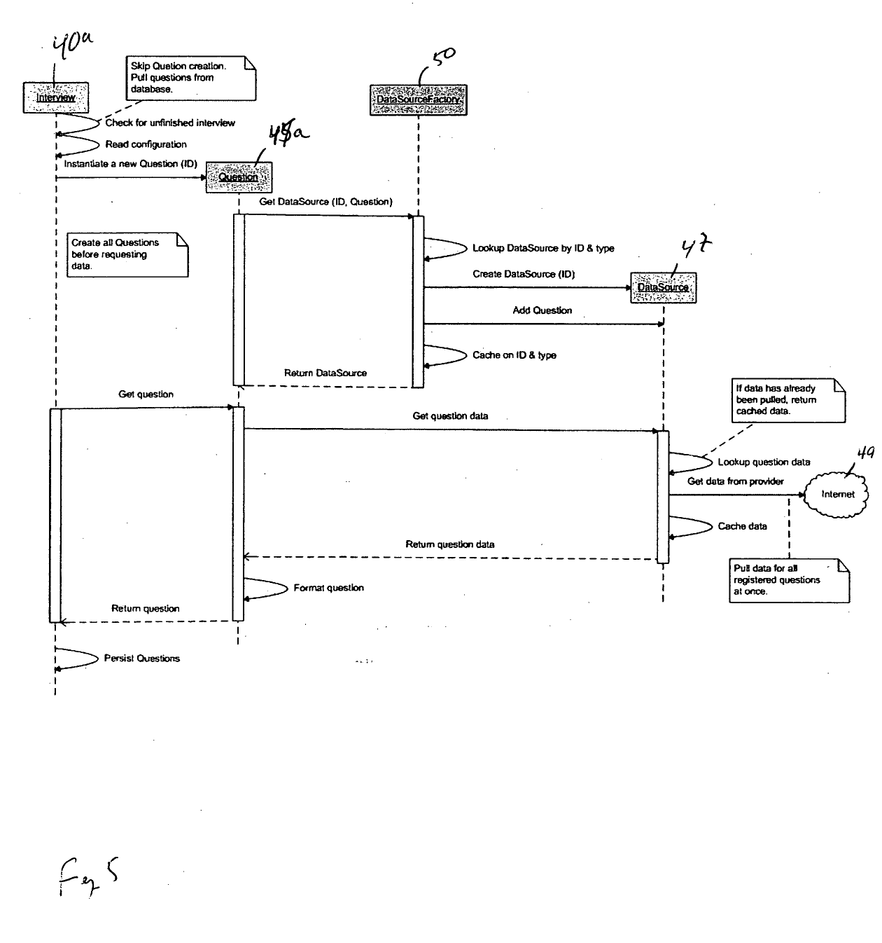

FIG. 4 is a block schematic diagram showing authentication service relations for an interview question request in an authentication ID interview method and apparatus according to the invention. In FIG. 4, a client configuration 42 is established for conducting interviews in accordance with the customer's parameters. In the example of FIG. 4, two interviews 40a/40b are shown. Each interview proceeds with a uniquely ordered set of questions, as discussed in greater detail below. Thus, a first interview 40a consists of questions 44a/45a drawn from a first data source 46 and a second data source 47, the first data source accessing a database 48 and the second data source accessing the Internet 49. Likewise, the second interview 40b consists of questions 44b/45b.

Those skilled in the art will appreciate that any number and type of data source may be used as a source of questions for each interview, and that different data sources may be accessed for each interview. The user interface for both the client and the interviewee is a matter of choice for those skilled in the art, but examples are provided herein. Such access may be via a communications network, an enterprise, or any other mode of eliciting responses to the questions posed.

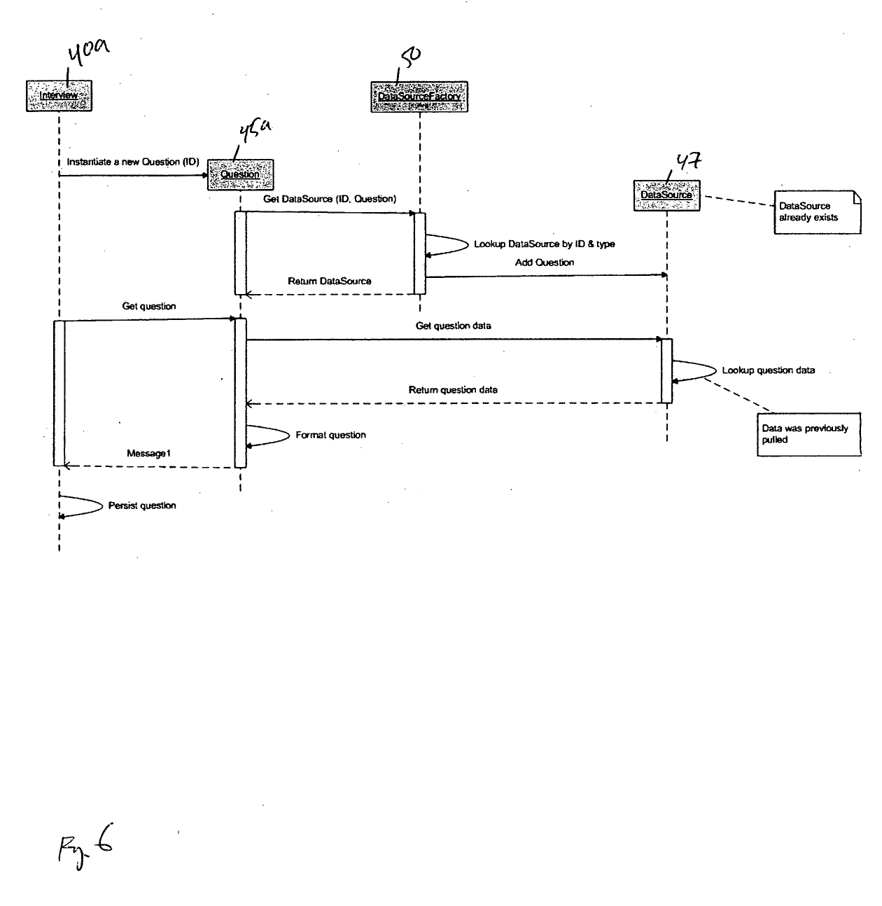

FIG. 5 is a block schematic diagram showing authentication service sequence for an interview question request during initial question creation using a new data source in an authentication ID interview method and apparatus according to the invention. Initially, the system can skip the question creation phase entirely and pull a question from the database 47. The system checks for an unfinished interview and reads the configuration 42 (FIG. 4). A new question 45a is then instantiated in connection with the data source factory 50. The system performs a get operation to the data source 47, specifying an ID and a question to be pulled. A lookup is performed on the data source by ID and type, the data source ID is created and the question is added. The question ID and type is then cached and the data source is returned. All questions to be created are created before data are requested.

Next, a get question routine can be performed to get question data. If the data have already been pulled, the cached data are returned. Otherwise, a lookup is performed for the question data. The data are pulled from the data provider, in this case the Internet 49. Data are pulled for all registered questions at the same time. The data are then cached, and the question data are returned. The question is formatted and returned. The questions are then stored in a persistent form.

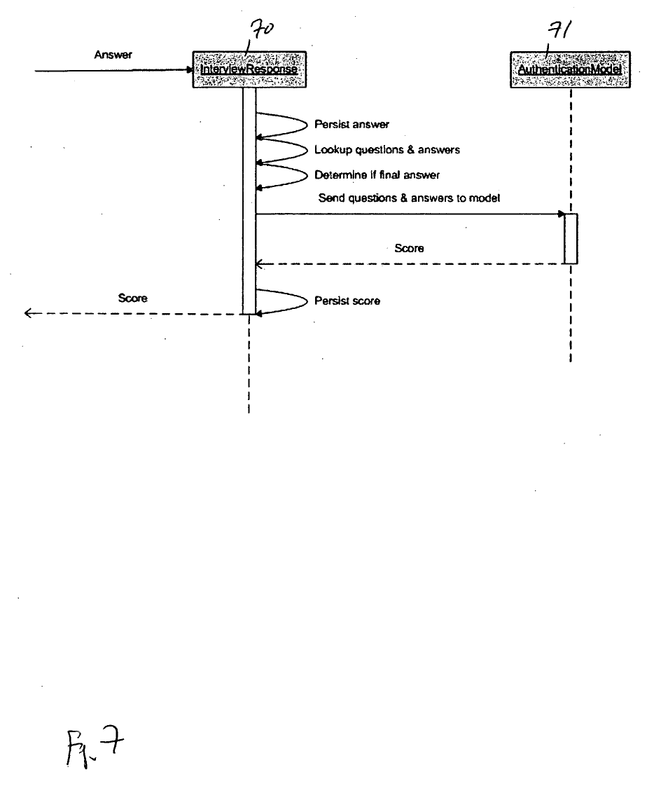

FIG. 6 is a block schematic diagram showing authentication service sequence for an interview question request during a subsequent question creation using an existing data source in an authentication ID interview method and apparatus according to the invention. In this case, the data source already exists and the data were previously pulled. Otherwise, the process of adding and requesting questions proceeds in a manner similar to that shown in FIG. 5.

FIG. 7 is a block schematic diagram showing authentication service sequence for an interview response when submitting a final answer to an interview in an authentication ID interview method and apparatus according to the invention. In FIG. 7, an answer is received as an interview response 70. The answer is stored, a lookup is performed of the questions and answers in the system, and a determination is made if this answer is the final answer to the interview. The questions and answers are then sent to an authentication model 71 and scored. The score is saved and returned.

Classes

The following are high-level classes that are intended to give an overview of type of classes involved in the presently preferred embodiment of the invention, and their responsibilities.

Interview

Creates interview ID
Reads institution's configuration
Determines questions—this could be done at random or by a model
Configures questions
Saves questions—database persisted by ID
   Question
Parses data
Formulates wrong answers—the data source returns the correct answer
Formats question
Formats answers

Questions are identified by a numeric question ID. The first two digits of the question ID indicates the category to which the question belongs.

Each question's data pull should be run on its own separate thread. The time it takes to get the question's data should be no longer than the slowest data provider.

Data Source Factory

Creates one data source of the same type per ID
   Data Source
Fetches requested data—all data from a single source should be fetched at once.
   Interview Response
Manage expiration time
Saves answers—database persisted by ID
Score interview—sends questions and answers to model for scoring
   Configuration
   Interview Configuration

Configurations are saved for each institution. The locale for the interview is specified in the initial interview request.

```
<interview_config>
    <name>FooTell</name>
    <size>3</size>
    <choices>5</choices>
    <issue_expiration>DD:HH:mm</issue_expiration>
<interview_expiration>DD:HH:mm</interview_expiration>
    <question id=“05001”/>
    <question id=“05003”/>
    <question id=“05004”/>
    <question id=“01005”/>
    <question id=“01009”/>
    <question id=“01017”/>
    <question id=“07006”/>
    <question id=“07011”/>
    <question id=“07012”/>
</interview_config>
```

Size—the number of questions in an interview.
Choices—the number of choices for each multi-choice answer.
Issue Expiration—the amount of time the interview is available.
Interview Expiration—the amount of time the interviewee has to complete the interview.
Question—the text of the question is resolved from a user configurable source.
Messages

Interview

```
<interview id=“566731234” taken=“0”>
    <question id=“05001”>
        <prompt>In which of the following cities have
you lived?</prompt>
        <choice>San Diego</choice>
        <choice>Boston</choice>
        <choice>Santa Cruz</choice>
        <choice>Salt Lake City</choice>
        <choice>Springfield</choice>
        <choice>None of the above</choice>
    </question>
    <question id=“01005”>
        <prompt>From whom did you purchase your current
residence?</prompt>
        <choice>Uncle Sam</choice>
        <choice>Big Bird</choice>
        <choice>Joe Blow</choice>
        <choice>Bill Gates</choice>
        <choice>Homer Simpson</choice>
    </question>
    <!-- Fill in the blank -->
    <question id=“07012”>
        <prompt>What is your mother's maiden
name?</prompt>
    </question>
</interview>
```

Taken—the number of previous interviews.
Interview Answers

Answers can be submitted one at a time or in batch. A score is returned when the final answer is submitted.

```
<interview_response id=“566731234”>
    <!-- Multiple choice with “none” option -->
    <question id=“05001”>
        <answer>San Diego</answer>
        <answer>Santa Cruz</answer>
    </question>
    <!-- Single choice -->
    <question id=“01005”>
        <answer>Bill Gates</answer>
    </question>
    <!-- Fill in the blank -->
    <question id=“07012”>
        <answer>Smith</answer>
    </question>
</interview_response>
```

Functional Requirements
Description: The Number of Authentication Interview Questions shall be Configurable.

Fit Criteria: The institution sets the number of questions to ask from the list of selected questions. The number of questions to ask can not be greater than the number of selected questions.

Rationale: An institution could select 50 questions that they deem appropriate. Of the selected question, any ten comprise an interview.

Description: The Number of Choices to an Authentication Interview Question shall be Configurable.

Fit Criteria: The institution sets the number of choices for a question. Each interview question contains the set number of choices. When this value is set it is effective for all of the institutions questions.

Rationale: The number of choices per question should be configurable on a per institution biases.

Description: It shall be Configurable Whether a Question should have a Single or Multiple Possible Correct Answers.

Fit Criteria: Questions configured as having multiple possible correct answers should display the choices with checkboxes or other means of multiple selection. The question may or may not have more than one correct answer.

Rationale: A question could have more than one correct answer. For example, “which of the following vehicles have you owned?”

Description: It shall be Configurable Whether to Allow “None” as a Possible Correct Answer.

Fit Criteria: A question configured as having possibly no correct choice has “None” or “None of the above” as one the choice. This choice should count against the configured number of choice. When this value is set it is effective for all of the institutions questions.

Rationale: A question could have no correct answers. This could be true if there is insufficient data for the Identity.

Description: Questions shall be Categorized Based on the Type Data Used to Form the Question.

Fit Criteria: The list of questions is displayed with the questions grouped by category.

Rationale: Questions are not categorized based on data source. Categories might include, property, vehicular, geographic, genealogy.

Description: Question Configurations shall be Saved for Each Institution.

Fit Criteria: Institutions should be able to customize their interviews.

Rationale: Each institution has a unique configuration.

Description: Questions Asked Shall be Saved by Identity.

Fit Criteria: Interview history is recalled using the defined Identity key.

Rationale: To track an Identity that has taken an interview at more than one institution.

Description: An Interview shall Make a Best Effort to be Unique

Fit Criteria: An interview should not contain questions asked at other institutions if there are questions configured that have not been asked.

Rationale: An interviewee should not be able to predict the interview questions before the interview has started.

Description: The Authentication Service shall Indicate the Number of Times an Identity has Taken an Interview.

Fit Criteria: The authentication service reports if an Identity has taken an interview more than once in X number of days.

Rationale: A fraud analyst should be aware that the Interviewee has taken a recent interview.

Description: An Interview shall Have a Configurable Expiration Time.

Fit Criteria: The institution configures the expiration time. The expiration time is incremented once the interview questions are requested. After the interview expires it should be assumed abandoned.

Rationale: Because some fraudsters do not attempt an interview, there must be a mechanism for tracking abandoned interviews.

Description: An Interview shall Always Start with the Last Unanswered Question.

Fit Criteria: If an interview is started and then postponed, the interview should continue with the last unanswered question. Never should the interview start from the beginning.

Rationale: The interview should never ask the same question more than once if the question has already been answered.

Description: There shall be a Configurable Amount of Time to Complete an Interview Once an Interview has Started.

Fit Criteria: The expiration time should start when the questions are generated and ignore any answers once the interview has expired. If the interview time expires the interview should be marked as abandoned.

Rationale: Interviewees should have a limited amount of time to complete the interview. Too much time may allow a potential fraudster to research the answer.

Description: The Authentication Service shall Allow By-Passing an Interview Based on User Supplied Credentials.

Fit Criteria: For victims of ID theft.

Rationale: The password would come from the consumer who has been a victim of an identity theft.

Description: It shall be Configurable Whether a Question should have a Fill in the Blank Answer.

Fit Criteria: The institution sets the question as a fill in the blank type. Each fill in the blank type interview question has a free text entry field.

Rationale: There are questions which the interviewee should know the exact answer without having to choose from a list. Fraudsters could also gain additional knowledge about an identity from some multiple choice questions, i.e. phone numbers.

Description: Questions shall be Identified by an Alpha-Numeric ID.

Fit Criteria: Each question should have a unique ID.

Rationale: Questions should not be dependant on the text or prompt. The wording of the question could change. The first two digits of the question ID should indicate the category to which the question belongs.

Description: Interviews shall be Identified by Both the Identity and the Institution.

Fit Criteria: Each interview by an institution has an identifier that is the same across all interviews. Each interviewee has an identifier that is the same regardless of the institution.

Rationale: A means of tying a completed interview back to its original source is necessary.

Description: Question Data Acquisition shall be Done in Parallel.

Fit Criteria: If acquiring data from provider 1 takes two seconds, data from provider 2 takes one second and data from provider 3 takes a half second, then it should take no longer than two seconds to acquire data for all questions for an interview.

Rationale: Acquiring data for questions shall take no longer than the slowest data provider.

Description: Questions shall be Presented One at a Time.

Fit Criteria: The interviewee should have to answer a question before being presented with the next question.

Rationale: The interviewee should not be able to see the all questions with out completing the interview. A potential fraudster could learn all the questions without taking an interviewing. Presenting questions one at a time provides the ability to choose the next question dynamically.

Authentication Scoring Overview

Questions and Responses

Assume that the total question pool Ω is a set of M different and unique questions, Ω={qᵢ, i=1, 2, . . . , M}.

Assume that each question qᵢ can generate a response Rᵢ from the customer which is either valid (Rᵢ=1) or invalid (Rᵢ=0). Skipping a question is not allowed.

For each question qᵢ, we know, or can estimate, the probabilities:
P(Rᵢ=1 interviewee is a non-fraud)
P(Rᵢ=1|interviewee is a fraud)

Let NF denote a non-fraud interviewee, F a fraudster's interviewee. Then,
P(Rᵢ=0|NF)=1−P(Rᵢ=1|NF)
P(Rᵢ=0|F)=1−P(Rᵢ=1|F)
and, for Rᵢ=0 or 1, the probability of getting an invalid or valid answer is computed as
P(Rᵢ)=P(Rᵢ|NF)*P(NF)+P(Rᵢ|F)*P(F),
where P(NF) is the probability that the interviewee is a non-fraud and P(F)=1−P(NF) is the probability that the interviewee is a fraud. Industry average values of P(F) and P(NF) may be used initially; the values may be refined as data are gathered.
Interviews

Suppose that an interview Q is a sequence of N≦M questions, Q₁ . . . Q_{N} selected (without replacement) from the set Q. In other words:
Q₁εΩ₁=Ω
QᵢεΩᵢ=Ωᵢ₋₁\{Qᵢ₋₁} for i=2, . . . , N.

When an interview
Q={Q₁, Q₂, Q₃, . . . , Q_{N}}
is administered, it generates the response:
R={R₁, R₂, R₃, . . . , R_{N}} where Rᵢε(0,1)

The interviewee must respond to question Qᵢ before question Q₁₊₁ is presented.

Computing the Score

We want to compute the probability the responder is a fraud (authentication score) given the returned series of responses R={R₁, R₂, R₃, . . . , R_{N}}.

For now, we shall say that a high score means high likelihood of fraud, so the interview score so that it is proportional to the probability of the interviewee being fraud: S(R)∝P(F|R). We need to compute P(F|R). Using Bayes' formula,

$$P ( F \vert R ) = \frac{P ( R \vert F ) * P ( F )}{P ( R )} ,$$

and we can compute estimates for the terms on the right hand side.

Notes: We can define the score as S(R)=round(1000*P(F|R)). Then 0≦S(R)≦1000. This score is high when there is a high likelihood of fraud.

The Case of Conditional Independence

The calculation of the score formula requires us to compute the composite probabilities P(R|F) and P(R). If the responses Rᵢ were independent of each other, i.e. that knowing the response given to one question does not influence the probabilities of the responses to future questions, the probability of seeing the response set could be calculated as the product of the individual response probabilities.
P(R)=P(R₁,R₂,R₃, . . . ,R_{N})=P(R₁)*P(R₂)*P(R₃)* . . . *P(R_{N})

The problem is that the responses, by virtue of their relationship to the fraud outcome, are indirectly related. As an extreme example, suppose both questions Q₁ and Q₂ are always answered incorrectly for a fraud and correctly for non-frauds. Then knowing the result for Q₁ means that we know the result for Q₂. Using the formula above leads to inconsistencies in the results.

A weaker form of independence, and one which corrects the above problem, is that of conditional independence. Two responses are conditionally independent if P(Rᵢ|Rⱼ, F)=P(Rᵢ|F). That is, the probability of the response for question i only depends on the response of question j insofar as they are both affected by the fraud value (and the same for the non-fraud case). Beyond this, the response to question Qⱼ carries no new information for question j.

Then we can compute the denominator using the formula
P(R)=P(R|NF)*P(NF)+P(R|F)*P(F)
which relies only on the conditional independence of the responses.

So, the raw score is computed as:

$$P ( F \vert R ) = \frac{P ( R \vert F ) * P ( F )}{P ( R \vert NF ) * P ( NF ) + P ( R \vert F ) * P ( F )}$$

with
P(R|F)=P(R₁,R₂,R₃, . . . ,R_{N}|F)=P(R₁|F)*P(R₂|F)*P(R₃|F)* . . . *P(R_{N}|F)
P(R|NF)=P(R₁,R₂,R₃, . . . ,R_{N}|NF)=P(R₁|NF)*P(R₂|NF)*P(R₃|NF)* . . . *P(R_{N}|NF)

Note that P(NF|R)=P(R|NF)*P(F)/P(R). Clearly, for good discrimination, we would like P(F|R) to be quite different from P(NF|R). That in turn is the case if, for each i, we have a big difference between P(Rᵢ|F) and P(Rᵢ|NF), and is maximized if (P(Rᵢ|F), P(Rᵢ|NF)) in (0,1) or (1,0).

The Case of Dependent Responses

Suppose that the responses are no longer simply conditionally independent, but that the response to question Qⱼ changes the expectations of the response Rₖ for question Qₖ, k>j, beyond their relation to the fraud value.

Then
P(R)=P(R₁)P(R₂) . . . P(Rⱼ) . . . P(Rₖ₋₁)P(Rₖ|Rⱼ)P(Rₖ₊₁) . . . P(R_{N})
P(R|F)=P(R₁|F)P(R2|F) . . . P(Rⱼ|F) . . . P(Rₖ₋₁|F)P(Rₖ|RⱼF)P(Rₖ₊₁|F) . . . P(R_{N}|F)

And the computation gives:

$$P ( F \vert R ) = \frac{P ( {R}_{1} \vert F ) P ( {R}_{2} \vert F ) … P ( {R}_{j} \vert F ) … P ( {R}_{k - 1} \vert F ) P ( {R}_{k} \vert {R}_{j} , F ) P ( {R}_{K + 1} \vert F ) … P ( {R}_{N} \vert F )}{P ( {R}_{1} ) P ( {R}_{2} ) … P ( {R}_{j} ) … P ( {R}_{k - 1} ) P ( {R}_{k} \vert {R}_{j} ) P ( {R}_{K + 1} ) … P ( {R}_{N} )} P ( F )$$

Generalizing, if Rᵢ depends on Rᵢ₋₁, Rᵢ₋₂, . . . , R₁, for i=2, 3, . . . , N, then
P(R)=P(R₁)P(R₂|R₁)P(R₃|R₂, R₁) . . . P(Rᵢ|Rᵢ₋₁, Rᵢ₋₂, . . . ,R₁) . . . P(R_{N}|R_{N-1}R_{N-2} . . . R₁)
P(R|F)=P(R₁|F)P(R₂|R₁, F)P(R₃|R₂,R₁,F) . . . P(Rᵢ|Rᵢ₋₁, Rᵢ₋₂, . . . ,R₁,F) . . . P(R_{N}|R_{N-1}R_{N-2} . . . R₁,F)

$$P ( F \vert R ) = \frac{{\prod }_{i = 1}^{N} P ( {R}_{i} \vert {R}_{i - 1} , {R}_{i - 2} , … {R}_{1} , F )}{{\prod }_{i = 1}^{N} P ( {R}_{i} \vert {R}_{i - 1} , {R}_{i - 2} , … {R}_{1} )} P ( F )$$

In general, there may be only a few dependencies amongst the questions. The internal representation of these probabilities may be stored in a dependency probability matrix.

Question Selection

Question selection is a key part of the interview design process. The client can control the number of questions in the interview N. The client has also selected the list of permissible questions. Let us say there are M (unique) questions that are permissible for this client, though we need to remember that other clients may allow questions off this set for the interviewee.

The goal of question selection is to choose questions that are new to the interviewee and which do not cover repetitive information, i.e. whose dependencies are minimal. In summary, the considerations are:
a) Randomize the questions;
b) No question may be repeated in the interview;
c) Suppress recently asked questions;
d) Avoid related questions (may use dependency probability matrix);
e) Select questions which provide maximum incremental information.

To address point c) we decide to suppress in the most recent P interviews. Suppose that an individual has taken J interviews, with Nₖ interviews in interview k (k=1 . . . J). Interview J+1 is now to be administered, with Nⱼ₊₁ permissible questions to be chosen from the available pool. The questions should not include those which were in the most recent P interviews, where P is a number to be chosen. It is impossible to be more granular than in the interviews. Valid values of P are integers lying between 0 (no memory) and P_{MAX} (full memory of past interviews). P_{MAX} is the minimum of J or S (the number of interviews beyond which there are fewer than N_{J+1} questions in the pool). To compute S, use the following algorithm:

```
Set S′ = 0, N_{left} = M
While N_{left} M − N_{J+1}
      S′ = S′ + 1
      N_{left} = N_{left} − N_{S′}
End While
S = S′ − 1
```

Then set P_{MAX}=MIN (J, S). Using P=P_{MAX} can result in interviews in which questions tend to cluster together in interviews; it might be better to choose something such as P=P_{MAX}−1.

Selection Algorithm

```
Set k = 0, Ω₀ = Ω, q₀ = ø
For i=1 .. N do
    Set k = k +1
    Set Ωₖ= Ωₖ₋₁ \ {qₖ₋₁}
    Randomly choose qₖ from Ωₖ
    While (DISCARD(qₖ))
        Set k = k +1
        Set Ωₖ= Ωₖ₋₁ \ {qₖ₋₁}
        Randomly choose qₖ from Ωₖ
    End While
    Set Qᵢ = qₖ
End For
Function DISCARD(qₖ)
If ((qₖ is not allowed by the client) or
    (EXCLUSION(qₖ)) or
    (unique_id(qₖ) in past P interviews)) then
      Return(1)
Else
      Return(0)
End If
End DISCARD
```

The random selection in the algorithm may be modified to depend on several factors, such as the cost associated with the question and the value of the particular question given by the preceding questions.

Question Library

The following tables provide examples of questions that may be presented during an interview.

TABLE 1
Question - SSN Issue Date

| | |
|---|---|
| QUESTION TYPE | Multiple Choice |
| DATA ELEMENT BEING | SSN Date of Issue |
| TESTED | |
| DATA KEYS | Social Security Number (first five digits) |
| TEXT OF THE QUESTION | In what year was your social security number |
| | issued? |
| | A. Between START(1) and END(1) (or ‘In |
| | START(1)’) |
| | B. Between START(2) and END(3) |
| | C. Between START(3) and END(3) |
| | D. Between START(4) and END(4) |
| | E. Between START(5) and END(5) |
| LOGIC FOR GENERATING | 1. Get EARLIEST_ISSUE_YEAR and |
| THE ANSWERS | LATEST_ISSUE_YEAR from the SSN |
| | ISSUE DATE table using the first five digits |
| | of the input SSN. |
| | 2. Randomly select K in 1, 2, 3, 4, 5. (The |
| | corresponding position of the correct |
| | answer is A, B, C, D, E.) |
| | Make sure that K ≧ (CURRENT_YEAR − |
| | LATEST_ISSUE_YEAR)/2 − 5, |
| | so that the |
| | algorithm doesn't lead to times out in the |
| | future. |
| | 3. Set START(K) to year in |
| | EARLIEST_ISSUE_YEAR |
| | SET END(K) to year in |
| | LATEST_ISSUE_YEAR. |
| | 4. FOR I = K − 1..1 |
| | Select SPAN randomly to be 1 or 2 |
| | Set START(I) = START(I + 1) − SPAN |
| | Set END(I) = START(I) + SPAN − 1 |
| | END |
| | 5. FOR I = K + 1..5 |
| | Select SPAN randomly to be 1 or 2 |
| | Set START(I) = END(I − 1) + 1 |
| | Set END(I) = START(I) + SPAN − 1 |
| | END |
| AUXILIARY DATA | SSN ISSUE YEAR Table |
| REQUIRED | |
| P(R = 1\|NON-FRAUD) | 0.8 |
| P(R = 1\|FRAUD) | 0.3 |
| REDUNDANT QUESTIONS | |
| NEVER LINKED | |
| QUESTIONS | |
| ALWAYS LINKED | |
| QUESTIONS | |
| LINK ORDER | |
| EXPECTED RESPONSE | 20 |
| TIME (SECONDS) | |
| NO-HIT CRITERIA | If SSN is missing or not in the table. |
| EXCLUSION | NO-HIT |

TABLE 2
Question - Property Price

| | |
|---|---|
| QUESTION TYPE | Multiple Choice |
| DATA ELEMENT | Property Price |
| BEING TESTED | |
| DATA KEYS | Name, Address |
| TEXT OF THE | How much did you pay for your property at (Address) |
| QUESTION | A. Between BIN_START(1) and BIN_END(1) |
| | B. Between BIN_START(2) and BIN_END(2) |
| | C. Between BIN_START(3) and BIN_END(3) |
| | D. Between BIN_START(4) and BIN_END(4) |
| | E. Between BIN_START(5) and BIN_END(5)? |
| LOGIC FOR | 1. Choose a random number to determine whether the |
| GENERATING | response will be in position 1, 2, 3, 4, or 5. Let K be |
| THE ANSWERS | the position of the true answer (K = 1, 2, 3, 4, or 5) |
| | 2. Set the BIN_WIDTH to be 50,000 if |
| | PROPERTY_PRICE is over 300,000, otherwise use |
| | BIN_WIDTH equals 20,000. |
| | 3. SET BIN_START(K) = |
| | BIN_WIDTH * TRUNC (PROPERTY_PRICE/BIN_WIDTH) |
| | 4. If PROPERTY_PRICE − BIN_START(K) < 0.1 * BIN_WIDTH, |
| | then set BIN_START(K) = BIN_START(K) − BIN_WIDTH/2. |
| | 5. If PROPERTY_PRICE − BIN_START(K) > 0.9 * BIN_WIDTH, |
| | then set BIN_START(K) = BIN_START(K) + BIN_WIDTH/2. |
| | 6. FOR I = 1..5 |
| | BIN_START(K) = BIN_START(K) + |
| | (I − K) * BIN_DIV) |
| | BIN_END(K) = BIN_START(K) + |
| | BIN_DIV |
| | END |
| AUXILIARY | None |
| DATA | |
| REQUIRED | |
| P(R = 1\|NON- | 0.8 |
| FRAUD) | |
| P(R = 1\|FRAUD) | 0.3 |
| REDUNDANT | |
| QUESTIONS | |
| NEVER LINKED | |
| QUESTIONS | |
| ALWAYS | |
| LINKED | |
| QUESTIONS | |
| LINK ORDER | |
| EXPECTED | 15 |
| RESPONSE | |
| TIME | |
| (SECONDS) | |
| NO-HIT | NO-HIT if the property does not exist, the address does |
| CRITERIA | not exist, or the address and name do not match. |
| EXCLUSIONS | NO-HIT. Redundant questions in interview. |

TABLE 3
Question - Property Purchase Year

| | |
|---|---|
| QUESTION TYPE | Multiple Choice |
| DATA ELEMENT BEING | Property Purchase Date |
| TESTED | |
| DATA KEYS | Name, Address |
| TEXT OF THE QUESTION | Which year did you buy your property at |
| | (ADDRESS) |
| | A. YEAR(1) |
| | B. YEAR(2) |
| | C. YEAR(3) |
| | D. YEAR(4) |
| LOGIC FOR GENERATING THE | 1. Choose a random number to |
| ANSWERS | determine whether the response will |
| | be in positions 1, 2, 3, 4, or 5. Let K |
| | be the position of the true answer (K = 1, |
| | 2, 3, 4) |
| | 2. Set YEAR(1) = year in SALE_DATE |
| | obtained from DATA SOURCE. |
| | 3. FOR I = 2..5 |
| | Randomly choose YEAR(K) |
| | If possible, assume a geometric |
| | distribution, with probability |
| | parameter p = 0.3 |
| | Otherwise use a uniform |
| | distribution. |
| | Re-choose if YEAR(I) has been |
| | used. |
| | END |
| | 4. Sort YEAR array, and indices permute |
| | to (1, 2, 3, 4, 5) -> (I1, I2, I3, I4, I5). K is now |
| | I1. |
| AUXILIARY DATA REQUIRED | None |
| P(R = 1\|NON-FRAUD) | 0.8 |
| P(R = 1\|FRAUD) | 0.4 |
| REDUNDANT QUESTIONS | LNPR003 |
| NEVER LINKED QUESTIONS | |
| ALWAYS LINKED QUESTIONS | |
| LINK ORDER | |
| EXPECTED RESPONSE TIME | 15 |
| (SECONDS) | |
| NO-HIT CRITERIA | NO-HIT if the property does not exist, the |
| | address does not exist, or the address |
| | and name do not match. |
| EXCLUSION | NO-HIT. Redundant questions selected |
| | for interview. |

TABLE 4
Question - 3 Fireplace

| | |
|---|---|
| QUESTION TYPE | Multiple Choice |
| DATA ELEMENT BEING | Fireplace |
| TESTED | |
| DATA KEYS | Address |
| TEXT OF THE QUESTION | Is there a built-in fireplace at |
| | (ADDRESS)? |
| | A. Yes |
| | B. No |
| LOGIC FOR GENERATING THE | Get FIREPLACE_NUMBER from |
| ANSWERS | relevant data source. Answer |
| | is ‘Yes’ if this value is |
| | greater than zero. |
| | Otherwise answer |
| | is ‘No’. |
| AUXILIARY DATA REQUIRED | None |
| P(R = 1\|NON-FRAUD) | 0.9 |
| P(R = 1\|FRAUD) | 0.6 |
| REDUNDANT QUESTIONS | |
| NEVER LINKED QUESTIONS | |
| ALWAYS LINKED QUESTIONS | |
| LINK ORDER | |
| EXPECTED RESPONSE TIME | 25 |
| (SECONDS) | |
| NO-HIT CRITERIA | NO-HIT if the property does |
| | not exist, the address |
| | does not exist. |
| EXCLUSIONS | NO-HIT. |

TABLE 5
Question - Aircraft Ownership

| | |
|---|---|
| QUESTION TYPE | Multiple Choice |
| DATA ELEMENT BEING | Aircraft Ownership |
| TESTED | |
| DATA KEYS | Name, Address |
| TEXT OF THE QUESTION | Which of the following aircraft do you |
| | own? |
| | A. MANUFACTURER - MODEL(1) |
| | B. MANUFACTURER - MODEL(2) |
| | C. MANUFACTURER - MODEL(3) |
| | D. MANUFACTURER - MODEL(4) |
| | E. MANUFACTURER - MODEL(5) |
| LOGIC FOR GENERATING | 1. Choose a random number to determine |
| THE ANSWERS | whether the response will be in |
| | position 1, 2, 3, 4, or 5. Let K be the |
| | position of the true answer (K = 1, 2, 3, |
| | 4, 5) |
| | 2. Get all existing |
| | MANUFACTURER/MODEL values for |
| | interviewee. Set |
| | MANUFACTURER_MODEL(K) to the |
| | first of these. |
| | 3. FOR I = 1..5, I != K |
| | Randomly choose |
| | MANUFACTURER - |
| | MODEL(I) from the vehicle table |
| | Re-choose if |
| | MANUFACTURER_MODEL(I) |
| | has already been used. |
| | Re-choose if |
| | MANUFACTURER_MODEL (I) |
| | is in the set of values for the |
| | interviewee. |
| | END |
| AUXILIARY DATA REQUIRED | Aircraft MANUFACTURER - MODEL Table |
| P(R = 1\|NON-FRAUD) | 0.85 |
| P(R = 1\|FRAUD) | 0.3 |
| REDUNDANT QUESTIONS | |
| NEVER LINKED QUESTIONS | |
| ALWAYS LINKED QUESTIONS | |
| LINK ORDER | |
| EXPECTED RESPONSE TIME | 20 |
| (SECONDS) | |
| NO-HIT CRITERIA | NO-HIT if the aircraft record does not exist, |
| | the address does not exist, or the address |
| | and name do not match. NO-HIT if |
| | MANUFACTURER and MODEL fields are |
| | not both populated. |
| EXCLUSIONS | NO-HIT |

TABLE 5
Question - Driver's License Corrective Lenses

| | |
|---|---|
| QUESTION TYPE | True or False |
| DATA ELEMENT BEING | Drivers License Corrective Lenses |
| TESTED | |
| DATA KEYS | Name, Address (or Driver's License |
| | Number) |
| TEXT OF THE QUESTION | You are required by law to wear |
| | corrective lenses to drive a car. |
| | A. TRUE |
| | B. FALSE |
| LOGIC FOR GENERATING | Check corrective lenses requirements on |
| THE ANSWERS | Driver's License. |
| AUXILIARY DATA | None |
| REQUIRED | |
| P(R = 1\|NON-FRAUD) | 0.9 |
| P(R = 1\|FRAUD) | 0.6 |
| REDUNDANT QUESTIONS | |
| NEVER LINKED | |
| QUESTIONS | |
| ALWAYS LINKED | |
| QUESTIONS | |
| LINK ORDER | |
| EXPECTED RESPONSE | 20 |
| TIME (SECONDS) | |
| NO-HIT CRITERIA | NO-HIT if the driver's license number |
| | is not retrieved or if it does not match the |
| | name and address. |
| NO-HIT ACTION | Do not use this question |

TABLE 6
Question - Employer

| | |
|---|---|
| QUESTION TYPE | Multiple Choice |
| DATA ELEMENT BEING | Employment Employer |
| TESTED | |
| DATA KEYS | Name, Address |
| TEXT OF THE QUESTION | Which of the following employers have you |
| | ever worked for? |
| | A. EMPLOYER(1) |
| | B. EMPLOYER(2) |
| | C. EMPLOYER(3) |
| | D. EMPLOYER(4) |
| | E. EMPLOYER(5) |
| LOGIC FOR GENERATING | 1. Extract all employment records for the |
| THE ANSWERS | individual. This will give a list of |
| | PAST_EMPLOYER(1), |
| | PAST_EMPLOYER(2), |
| | ....PAST_EMPLOYER(N). Randomly |
| | choose the integer M, from 1..N. Set |
| | TRUE_EMPLOYER = PAST_EMPLOYER(M). |
| | 2. Choose a random number to determine |
| | whether the correct response will be in |
| | position 1, 2, 3, 4, or 5. Let K be the |
| | position of the true answer (K = 1, 2, 3, 4, |
| | 5). SET EMPLOYER(K) = TRUE_EMPLOYER. |
| | 3. FOR I = 1..5, I != K |
| | Choose EMPLOYER(I) from Employer |
| | database |
| | Re-choose if EMPLOYER(I) is already |
| | taken |
| | Re-choose if EMPLOYER(I) is in |
| | the PAST_EMPLOYERS list |
| | END |
| AUXILIARY DATA | Employer database |
| REQUIRED | |
| P(R = 1\|NON-FRAUD) | 0.85 |
| P(R = 1\|FRAUD) | 0.3 |
| REDUNDANT QUESTIONS | |
| NEVER LINKED | |
| QUESTIONS | |
| ALWAYS LINKED | |
| QUESTIONS | |
| LINK ORDER | |
| EXPECTED RESPONSE | 20 |
| TIME (SECONDS) | |
| NO-HIT CRITERIA | NO-HIT if no employment records exist, or if |
| | the address and name do not match. NO-HIT |
| | if EMPLOYER NAME field is not populated. |
| EXCLUSIONS | NO-HIT. |

TABLE 7
Question - Relative Identification

| | |
|---|---|
| QUESTION TYPE | Multiple Choice |
| DATA ELEMENT BEING | Relative Identification |
| TESTED | |
| DATA KEYS | Name, Address |
| TEXT OF THE QUESTION | Which of the following people do you know? |
| | A. PERSON(1) |
| | B. PERSON(2) |
| | C. PERSON(3) |
| | D. PERSON(4) |
| | E. PERSON(5) |
| LOGIC FOR GENERATING | 1. Extract all relative records for the |
| THE ANSWERS | individual. This will give a list of REL(1), |
| | REL(2), ....REL(N). Randomly choose the |
| | integer M, from 1..N. Set TRUE_REL = REL(M). |
| | 2. Choose a random number to determine |
| | whether the response will be in position 1, |
| | 2, 3, 4, or 5. Let K be the position of the |
| | true answer (K = 1, 2, 3, 4, 5) |
| | 3. FOR I = 1..5, I != K |
| | Randomly select PERSON(I) from the |
| | NAME table (FIRST/MID/LAST). |
| | Choose random integer between 0 and |
| | 99. |
| | If RAN_NUM < 20, then |
| | set LASTNAME of PERSON(I) = |
| | LASTNAME of applicant. |
| | Re-choose if PERSON(I) has been |
| | used already |
| | Re-choose if PERSON(I) exists on any |
| | of the |
| | relative records. |
| | END |
| AUXILIARY DATA | NAME Table |
| REQUIRED | |
| P(R = 1\|NON-FRAUD) | 0.7 |
| P(R = 1\|FRAUD) | 0.3 |
| REDUNDANT QUESTIONS | |
| NEVER LINKED | |
| QUESTIONS | |
| ALWAYS LINKED | |
| QUESTIONS | |
| LINK ORDER | |
| EXPECTED RESPONSE | 20 |
| TIME (SECONDS) | |
| NO-HIT CRITERIA | NO-HIT if no relative records exist. |
| EXCLUSIONS | NO-HIT. |

Auxiliary Data

Computing the questions requires auxiliary data, in general to formulate the fraud answers. The different data files are documented below.

SSN ISSUE YEAR Table

| | |
|---|---|
| Detail: | Dates when SSNs were issued |
| FORMAT: | Bar-delimited. |
| SSN5(FIRST) | 99999 |
| EARLIEST_ISSUE_YEAR | YYYY |
| LATEST_ISSUE_YEAR | YYYY |
| Comments: | An entry only exists if a valid ssn is given. |

Average Property Sizes

| | |
|---|---|
| Detail: | Contains average property sizes (in square feet) per zip3 |
| FORMAT: | ZIP3; MEAN_PROPERTY_SIZE. |

Subdivision Table

Detail: The subdivision list contains a list of subdivisions for the
question “What subdivision is (Property address) in?”
FORMAT: One subdivision per line. May contain blanks.
Alphabetically sorted.

Property Type Table

Detail: Types of properties, from DATA_SOURCE data
FORMAT: PROPERTY_INDICATOR on each record

Aircraft Manufacturer-Model Table

Detail: List of Aircraft Manufacturer and Models, from DATA_SOURCE
FORMAT: AIRCRAFT_MANUFACTURER;
AIRCRAFT_MODEL. Tab-delimited.

U.S. State Table

Detail: List of the States
FORMAT: STATE_NAME; STATE_ABBREVIATION. Tab-delimited.

Employer Tables

Detail: List of Employers
FORMAT: One employer name per record (may contain spaces).

City-State Tables

Detail: Tables of Cities and States
FORMAT: STATE; CITY. Tab-delimited. Sorted by State and then City.
Multiple entries per STATE.

NAME Table

Detail: Names from the consortium database
FORMAT: FIRST_NAME; MIDDLE_INITIAL; LAST_NAME.
Bar-delimited.
Comments: The last name may contain a suffix associated with it.

Technical Implementation
Exemplary Digital Data Processing Apparatus

Data processing entities such as a computer may be implemented in various forms. One example is a digital data processing apparatus, as exemplified by the hardware components and interconnections of a digital data processing apparatus.

As is known in the art, such apparatus includes a processor, such as a microprocessor, personal computer, workstation, controller, microcontroller, state machine, or other processing machine, coupled to storage. In the present example, the storage includes a fast-access storage, as well as nonvolatile storage. The fast-access storage may comprise random access memory (“RAM”), and may be used to store the programming instructions executed by the processor. The nonvolatile storage may comprise, for example, battery backup RAM, EEPROM, flash PROM, one or more magnetic data storage disks such as a hard drive, a tape drive, or any other suitable storage device. The apparatus also includes an input/output, such as a line, bus, cable, electromagnetic link, or other means for the processor to exchange data with other hardware external to the apparatus.

Despite the specific foregoing description, ordinarily skilled artisans (having the benefit of this disclosure) will recognize that the invention discussed above may be implemented in a machine of different construction, without departing from the scope of the invention. As a specific example, one of the components may be eliminated; furthermore, the storage may be provided on-board the processor, or even provided externally to the apparatus.

Logic Circuitry

In contrast to the digital data processing apparatus discussed above, a different embodiment of this disclosure uses logic circuitry instead of computer-executed instructions to implement processing entities of the system. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS, TTL, VLSI, or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

Signal-Bearing Media

Wherever the functionality of any operational components of the disclosure is implemented using one or more machine-executed program sequences, these sequences may be embodied in various forms of signal-bearing media. Such a signal-bearing media may comprise, for example, the storage or another signal-bearing media, such as a magnetic data storage diskette, directly or indirectly accessible by a processor. Whether contained in the storage, diskette, or elsewhere, the instructions may be stored on a variety of machine-readable data storage media. Some examples include direct access storage, e.g. a conventional hard drive, redundant array of inexpensive disks (“RAID”), or another direct access storage device (“DASD”), serial-access storage such as magnetic or optical tape, electronic non-volatile memory, e.g. ROM, EPROM, flash PROM, or EEPROM, battery backup RAM, optical storage e.g. CD-ROM, WORM, DVD, digital optical tape, or other suitable signal-bearing media including analog or digital transmission media and analog and communication links and wireless communications. In one embodiment, the machine-readable instructions may comprise software object code, compiled from a language such as assembly language, C, etc.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method for determining whether an individual is who he says he is, comprising the steps of:
posing a series of questions drawn from various data providers to the individual;
evaluating responses to said series of questions; and
scoring said responses to determine the likelihood that correct/incorrect responses to said series of questions is indicative of fraud.

2. A computer implemented authentication method for determining if an identity is true or not, comprising the steps of:
generating a series of questions from a range of categories;
providing an interview to a person having an identity that is in question; and
scoring resulting answers with an authentication service.

3. The method of claim 2, wherein display of interview questions is configurable by an interviewer.

4. The method of claim 2, wherein specific questions are chosen by an interviewer from a pool of possible questions.

5. The method of claim 2, further comprising the step of:
setting a number of questions that comprise an interview from a pool of selected questions.

6. The method of claim 2, wherein presentation of choices is configurable.

7. The method of claim 2, wherein with regard to responding to said interview there can be any of one or more correct choices, a “none” choice, or an answer can be supplied by an interviewee.

8. The method of claim 2, wherein results of an interview are stored in a clearinghouse.

9. The method of claim 2, wherein if an interviewee attempts another, new interview, either at a different or a same institution, questions contained in said new interview are as substantially unique.

10. The method of claim 2, further comprising the step of:
said authentication service first exhausting all questions that have not been presented to an interviewee before using previously asked questions.

11. The method of claim 2, further comprising the step of:
providing an interviewee with a predetermined amount of time to complete said interview.

12. The method of claim 11, wherein if an interview is not completed in said predetermined amount of time, said interview is assumed abandoned.

13. The method of claim 2, further comprising the step of:
always starting an interview with a last unanswered question if an interviewee postpones said interview it.

14. The method of claim 2, wherein an interviewee never has an opportunity to correct a previous answer.

15. An apparatus for authenticating an individual's identity, comprising:
an interview module for any of creating an interview ID, reading an institution's configuration, determining questions either randomly or by a model, configuring questions, and saving questions in a database persisted by ID;
a question module for any of parsing data, formulating wrong answers wherein a data source returns a correct answer, formatting questions, and formatting answers;
a plurality of questions that are identified by a numeric question ID, wherein at least a portion of said question ID indicates a category in which said question belongs;
a data source factory for creating at least one data source of a same type per ID;
at least one data source for fetching requested data; and
an interview response module for managing expiration time, saving answers in a database persisted by ID, scoring an interview by sends questions and answers to a scoring model for scoring.

16. The apparatus of claim 15, further comprising:
means for any of an institution controlling a number of questions in an interview and selecting a list of permissible questions.

17. The apparatus of claim 15, further comprising:
means for choosing questions that are new to an interviewee and which do not cover repetitive information.

18. An apparatus for authenticating an individual's identity, comprising:
means for generating a series of questions from a range of categories;
means for providing an interview to a person having an identity that is in question; and
means for scoring resulting answers with an authentication service.

19. The apparatus of claim 18, further comprising:
means for randomizing questions presented to said individual during an interview;
wherein no questions are repeated during an interview;
wherein recently asked questions are suppressed; and
wherein related questions are avoided.

20. An apparatus for determining whether an individual is who he says he is, comprising:
means for posing a series of questions drawn from various data providers to the individual;
means for evaluating responses to said series of questions; and
means for scoring said responses to determine the likelihood that correct/incorrect responses to said series of questions is indicative of fraud.

21. The apparatus of claim 20, said means for scoring producing a numeric score for each completed interview;
wherein said score predicts a likelihood an interview is who he says he is.

22. The apparatus of claim 20, wherein a score for an interview is determined by individual responses to said questions making up the interview.

23. The apparatus of claim 22, wherein a response to each and every question contributes to an overall interview score.

24. The apparatus of claim 20, wherein impact of a particular question to an interview score depends on a response said individual makes to said question.

25. The apparatus of claim 24, wherein said score is adjusted according to a likelihood of an impersonator giving a particular response versus an overall likelihood of getting said response;
wherein certain questions are weighted as being better at distinguishing between fraud and non-fraud than other questions.

26. The apparatus of claim 20, wherein an amount of score adjustment is made due to a given response to a question based on an empirical analysis.

27. The apparatus of claim 26, wherein the impact of each question on the score is based on a statistical analysis of how known frauds and non-frauds respond to the question, respectively.

28. The apparatus of claim 20, wherein a score contribution for each question is affected by responses said individual gives to preceding questions in said interview.

29. The apparatus of claim 20, wherein said means for posing questions, in generating an interview, chooses questions from a library depending on how much value the chosen questions add to the score.

30. The apparatus of claim 29, wherein questions are chosen dynamically, with a new question asked as the old questions are chosen, wherein said choice increases the information value of said questions.

31. A method for determining whether an individual is who he says he is, comprising:
providing an interview to a person having an identity that is in question;
posing a series of questions drawn from various data providers to said individual during said interview;
evaluating responses to said series of questions; and
scoring said responses to determine the likelihood that correct/incorrect responses to said series of questions is indicative of fraud.

32. The method of claim 31, scoring step further comprising the step of:
producing a numeric score for each completed interview;
wherein said score predicts a likelihood an interview is who he says he is.

33. The method of claim 31, wherein a score for an interview is determined by individual responses to said questions making up the interview.

34. The method of claim 23, wherein a response to each and every question contributes to an overall interview score.

35. The method of claim 31, wherein impact of a particular question to an interview score depends on a response said individual makes to said question.

36. The method of claim 35, further comprising the steps of:
adjusting said score according to a likelihood of an impersonator giving a particular response versus an overall likelihood of getting said response; and
weighting certain questions as being better at distinguishing between fraud and non-fraud than other questions.

37. The method of claim 31, further comprising the step of:
making an amount of score adjustment due to a given response to a question based on an empirical analysis.

38. The method of claim 37, further comprising the step of:
basing the impact of each question on the score on a statistical analysis of how known frauds and non-frauds respond to the question, respectively.

39. The method of claim 31, wherein a score contribution for each question is affected by responses said individual gives to preceding questions in said interview.

40. The method of claim 31, further comprising the step of:
when generating an interview, choosing questions from a library depending on how much value the chosen questions add to the score.

41. The method of claim 40, further comprising the step of:
choosing questions dynamically, with a new question asked as the old questions are chosen, wherein said choice increases the information value of said questions.
